(19) United States
(12) Patent Application Publication
(10) Pub. No.: US 2011/0251931 A1
(43) Pub. Date: Oct. 13, 2011

(54) Accurate Method of Account Checking in the Situation of 7*24 Hours Transactions Between Telecom Multiple Systems

(75) Inventors: MAOCHUN LI, Nanjing (CN); QIAN LI, Nanjing (CN); ZHONG LIN, Nanjing (CN); QINGTONG XUE, Nanjing (CN); ZHIGANG YU, Nanjing (CN); PENG CUI, Nanjing, Jiangsu (CN); XIAOYING HUANG, Nanjing (CN); JIANBAO LI, Nanjing (CN)

(73) Assignee: LINKAGE TECHNOLOGY GROUP CO., LTD., Nanjing (CN)

(21) Appl. No.: 13/016,150

(22) Filed: Jan. 28, 2011

(30) Foreign Application Priority Data
Feb. 5, 2010 (CN) 201019026102.X

(51) Int. Cl. G06Q 10/00

(52) U.S. Cl. 705/30

(57) ABSTRACT

This article is about the accurate method of account checking in the situation of 7×24 hours transactions between telecom multiple systems. The systems we discussed here provide services individually. There is an Account Checking Controlling Server, and all the systems are connected with the Account Checking Controlling Server, the transaction between systems is distributed by Account Checking Controlling Server. Account Checking Controlling Server is in charge of control and manage the transaction of account checking between systems, it is consists of transaction management module, account checking cycle management module, transaction flow module and account checking management module. Transaction management module is in charge of storage and handle the system information and the system distribute rules. Account checking cycle management module is responsible for create and manage the account checking cycle. Transaction flow module realize the specific transaction. Account checking management module is responsible for account checking. This invention realize account checking accurately, it can do account checking timely, accurately, and don't affect the systems 7*24 hours running, when account checking cycle ended, account checking is automatically invoked, so we can find problems as soon as possible.

### FIELD OF THE INVENTION

This invention belongs telecom operator's large-scale cross system accurately data processing technology, as an accurate method of account checking in the situation of 7*24 hours transactions between telecom multiple systems.

### BACKGROUND OF THE INVENTION

Along with the development of communication technology, our country's communication network is constantly expansion, and the businesses of telecom operators are in the unceasing development. On one hand, there are more and more business types, On the other hand, the usage of each business is getting higher and higher. Meanwhile, telecom operators put forward new requirements in operation management continuously. A few years ago, production mode of China telecom was local network, but now most provinces have realized the centralized management and production. The transaction volume increased, centralized and unified operation mode, proposed high requirements to the supporting system for telecom operators, especially the processing ability of billing account system. For example, JiangSu telecom has more than 40 million subscribers, there will be more than two million times transactions concurrently one second at peak periods.

Such the concurrent volume, single host and system is difficult to implement, and also the investment is too much. Normally, using cluster to improve the processing ability, each host running system independently and provides some customer services, these systems are cooperate with others, they provide services in an unified form. Because each system undertake the calculation for its customer businesses, when it encounters the customer businesses across systems, we will need cooperation between systems, any two system may exist cooperation, so a mesh network is formed. See FIG. 1.

The transaction across systems is completed by two different systems together, theoretically both successful or back is requirement, the total transaction volume and the detail should be identical, but in fact, because the reasons of network, artificial operation etc, there will be “unilateral account”, namely a transaction is recorded successfully only in one system. Failure may be occur due to the system itself or communication reasons, for example, the following scenes.

How to find these problems? A effective method is do account checking. Account checking, namely collect the transaction records in the system at a given time after transaction has completed, to find problems by compare data according to the predetermined rules. To meet the requirements of production, account checking must satisfy several conditions as follows:

1) Timely: account checking must timely, so we can find problems and correct them as soon as possible;

2) Accurately: the calculation must accurately, because it's the basic guarantee for the system running normally;

3) It shouldn't affect the 7×24 hours service of each system;
7×24 hours service here means the service is constantly provided by telecom 24 hours a day, 7 days a week.

To meet the three conditions above, there are many challenges, we find several issues to consider in practice:

1) Clock differences between different platforms. Due to the transaction is between two different systems, if clocks are not synchronous in the two systems, there will be errors when collect the data, this cause defects of the account checking itself.

2) Differences of account checking cycle. Different types of business or different rules requires different account checking cycle, for example, a month, a week, a day, an hour or a minute. Especially when the time granularity is too fine, often the data of the last account checking cycle isn't finished, the next has arrived. The flow is confused when do account checking concurrently, also it's difficult to track the problems later.

3) Irregular account checking. Account checking of some systems is entirely artificial triggered, there is no rules to follow, so account checking cycle is irregular.

4) Who launched the account checking in the mesh network.

### SUMMARY OF THE INVENTION

This invention will solve the problem: when we do account checking cross the existing telecom systems, due to clock differences, account checking cycle differences, irregular account checking, and who launched the account checking, it can't achieve timely and accurately, so we should provide a new method of account checking: it can do account checking timely and accurately, and don't affect the systems 7*24 hours running.

Technical solutions of this invention is: the accurate method of account checking in the situation of 7*24 hours transactions between telecom multiple systems, The systems we discussed here can provide services individual, and also cooperate with others, they provide services in an unified form. There is an Account Checking Controlling Server, and all the systems are connected with the Account Checking Controlling Servers, the transaction between systems is distributed by the Account Checking Controlling Servers, and it's also in charge of control and manage the transaction of account checking between systems. Account Checking Controlling Servers consists of transaction management module, account checking cycle management module, transaction flow module and account checking management module.

Transaction management module is in charge of storage and handle the system information and the system distribute rules.

Account checking cycle management module is in charge of create account checking cycle and manage it, each transaction of system associate with an account checking cycle. The account checking cycle including attributes as follows: account checking cycle descriptor (the unique descriptor of account checking); start time (the transaction's start time of an account checking); end time (the transaction's end time of an account checking); the state of account checking cycle (1. occupy: the cycle is in transaction now; 2. close: the cycle had already closed, waiting for account checking; 3. account checking: the cycle is in account checking now; 4. archive: account checking had already finished).

Transaction flow module is in charge of the specific transaction and distribute the transaction between systems according to the account checking cycle.

Account checking management module is responsible for collect the transaction data, and provides account checking operations according to the account checking cycle.

Transaction management module provide the function of add, modify, delete the system information and the system distribute rules. The system information including: system descriptor, hostname, host ip, log directory, user/password; The system's distribute rules including: Section No., system descriptor (it's a reference to system descriptor in system information).

In Account checking cycle management module, the start time and the end time of the account checking cycle is shielding outside and is just managed in Account Checking Controlling Server by account checking cycle management module according to cycles switching event, the cycles switching event is triggered by the external according to cycle or by artificial; the system get an account checking cycle descriptor for each transaction, and associate the transaction with the account checking cycle, later, account checking is based on the account checking cycle, the action of account checking is defined as an operation process of transactions comparison in an account checking cycle.

Cycles switching event specific realization as follows: set the step of account checking cycle, and account checking cycle management module can create a new account checking cycle according to the step we have already set or by an artificial event, at the same time it closes the last account checking cycle.

Transaction flow module specific realization is: assume that a transaction is requested by system A, the opposite end is system B:

a) System A make a request for transaction, and send it to Account Checking Controlling Server;

b) Account Checking Controlling Server modify the transaction information which system A has requested, and insert an account checking cycle descriptor, associate the transaction with the account checking cycle, then the transaction information is transferred to system B;

c) System B do some corresponding processing, record the transaction information data which contains an account checking cycle descriptor, and send a response information which also contains the account checking cycle descriptor to Account Checking Controlling Server;

d) Account Checking Controlling Server transfer the response information (from system B) to system A

e) System A record the transaction information data which contains the account checking cycle descriptor.

Transaction flow module of this invention using tuxedo mode or socket mode to transfer the transaction request information and transaction response information. When using tuxedo mode, we can use the tuxedo's event trigger; when using socket mode, we can use the message queue of System V to store the request and response information, transaction distribute can realize the event trigger through access the message queue.

Request information forwarding specific realization as follows:
a) Account Checking Controlling Server receive the transaction request by event trigger;
b) Get an account checking cycle descriptor from account checking cycle management module, which associate with an account checking cycle, set the state of account checking cycle to occupy;
c) Modify the transaction request information, insert the account checking cycle descriptor (which we got by step b) into the transaction request information;
d) Analyze the target system according to the corresponding field in the request information;
e) Transfer the request information to target system;
f) Account Checking Controlling Server record the corresponding operation logs, as the auxiliary information for account checking
   Response information forwarding specific realization as follows:

a) Account Checking Controlling Server receive the transaction response by event trigger;

b) Analyze the target system according to the corresponding field in the response information;

c) Transfer the response information to target system;

d) Account Checking Controlling Server record the corresponding operation logs, as the auxiliary information for account checking.

In this invention, when closed an account checking cycle, Account checking management module is automatically invoked to do the operations of account checking, account checking management specific realization as follows:

a) Detect the state of the account checking cycle which is closed;

b) Download the transaction data of this account checking cycle from all systems by ftp mode;

c) Analyze the data, check whether there is abnormal data;

d) If the data is normal, record logs directly, and modify the state of the account checking cycle to archive;

e) If the data is abnormal, do some adjustments, then record logs and modify the state of the account checking cycle to archive.

The beneficial effects of this invention is: because of using the same account checking cycle, we can do account checking timely and accurately, and this don't affect other systems 7*24 hours running normally. Account checking is automatically invoked when account checking cycle ended, so we can find problems as soon as possible. This method provides a good solution for the problems we will meet during account checking:

a) Unsynchronized clock problems in different platforms. This invention brings account checking cycle descriptor as the unit of account checking, thereby we can avoid the difficulties which is caused by unsynchronized clock in different platforms when do account checking;

b) Differences of account checking cycle. Account checking cycle is managed by Account Checking Controlling Server according to the rules of business type, so it can avoid the confusion of the account checking cycles;

c) Irregular account checking. This invention unify account checking management, and execute the regulations which the system had already set;

d) Who launched the account checking. According to the state of account billing cycle, account checking is invoked automatically by account checking management module.

### BRIEF DESCRIPTION OF THE DRAWINGS

FIG. 1 is schematic for existing technology of China telecom multiple systems

FIG. 2 is schematic for this invention

FIG. 3 is schematic for transaction flow module in this invention

FIG. 4 is schematic for create account checking cycle by account checking cycle management module in this invention

FIG. 5 is schematic for forward transaction request of transaction flow module in this invention

FIG. 6 is schematic for forward transaction response of transaction flow module in this invention

FIG. 7 is schematic for specific implementation of account checking management module in this invention

### DETAIL DESCRIPTION OF THE INVENTION

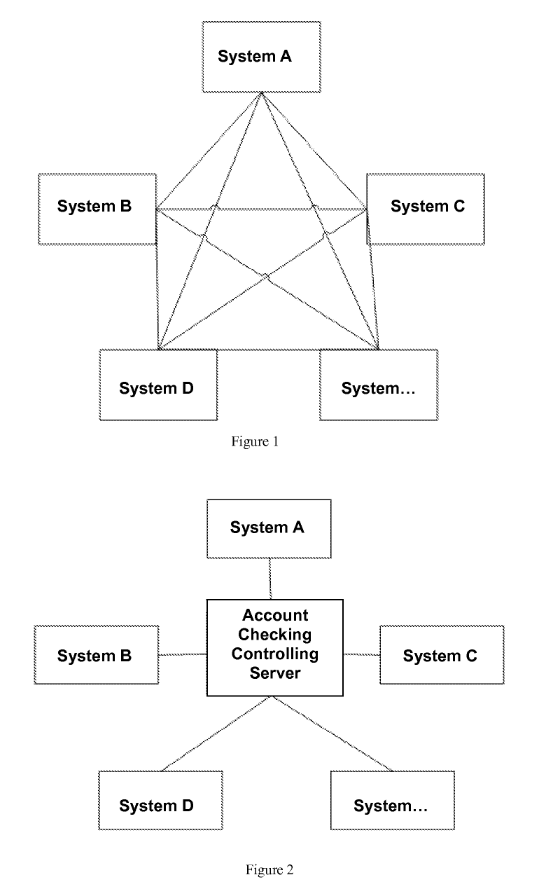

For the scenes of the transaction in the china telecom multiple systems, this invention gives a solution for accurate account checking. The systems we discussed here can provide services individual, and also cooperate with others, they provide services in an unified form. This invention establish Account Checking Controlling Server, and all the systems are connected with Account Checking Controlling Server, the transaction between systems is transferred by Account Checking Controlling Server, see FIG. 2. Account Checking Controlling Server is in charge of control and manage the transaction of account checking between systems; it consists of transaction management module, account checking cycle management module, transaction flow module and account checking management module.

Transaction management module is in charge of storage and handle the system information and the system distribute rules.

Account checking cycle management module is in charge of create account checking cycle and manage it, each transaction of system associate with a cycle. The account checking cycle including attributes as follows: account checking cycle descriptor (the unique descriptor of account checking); start time (the transaction's start time of an account checking); end time (the transaction's end time of an account checking); the state of account checking cycle (1. occupy: the cycle is in transaction now; 2. close: the cycle had already closed, waiting for account checking; 3. account checking: the cycle is in account checking now; 4. archive: account checking had already finished).

Transaction flow module is in charge of the specific transaction and distribute the transaction between systems according to the account checking cycle.

Account checking management module is responsible for collect the transaction data, and provides account checking operations according to account checking cycle.

The specific implementation of this invention is as follows:

1. Establish Account Checking Controlling Server
Establish Account Checking Controlling Server in multiple systems, so any cooperation between systems no longer need to connected directly, they all connected to Account Checking Controlling Server now, so a star connection is formed. Any transaction between systems is transferred through Account Checking Controlling Server. Transaction management module, account checking cycle management module, transaction flow module and account checking management module are deployed in Account Checking Controlling Server. Account Checking Controlling Server is the core node for account checking between multiple systems.

2. Transaction Management Module
All systems are connected to Account Checking Controlling Server, Account Checking Controlling Server is responsible for manage the system information and the system's distribute rules, including the function of add, modify and delete, all these are realized by transaction management module. The system information including: system descriptor, hostname, host ip, log directory, user/password, etc; The system's distribute rules including: Section No., system descriptor (it's a reference to system descriptor in system information).

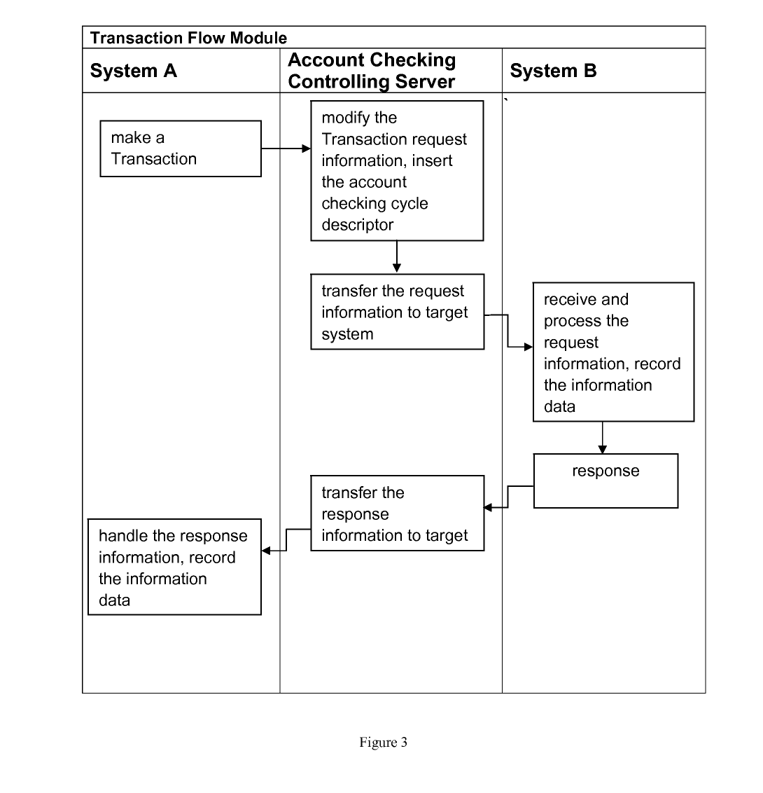

3. Account Checking Cycle Management Module
Account checking cycle management module provide the functions of create account checking cycle, get account checking cycle, and manage the state of account checking cycle.
Account checking cycle entity has attributes as follows: account checking cycle descriptor (the unique descriptor of account checking); start time (the transaction's start time of an account checking); end time (the transaction's end time of an account checking); the state of account checking cycle (1. occupy: the cycle is in transaction now; 2. close: the cycle had already closed, waiting for account checking; 3. account checking: the cycle is in account checking now; 4. archive: account checking had already completed).
Create the account checking cycle: in account checking cycle management module, the start time and the end time of account checking cycle is shielding outside and is just managed in Account Checking Controlling Server by account checking cycle management module according to cycles switching event, the cycles switching event is triggered by the external according to cycle or by artificial; cycles switching event specific realization as follows: set the step of account checking cycle, and account checking cycle management module can create a new account checking cycle according to the step we have already set or by an artificial event, at the same time it closes the last account checking cycle. To get more about the flow of create account checking cycle, please see FIG. 3.
Get account checking cycle: the system get an account checking cycle descriptor for each transaction, and associate the transaction with the account checking cycle, later, account checking is based on the account checking cycle, the action of account checking is defined as a process of transactions comparison in an account checking cycle. According to the state parameters which was brought in, namely whether there is a transaction transferred request, modify the state of the account checking cycle. This function is mainly provided to the transaction transfer flow for modify the account checking cycle descriptor of the transaction information, or provided to the account checking manage flow for getting the account checking cycle descriptor which is waiting for do account checking
State manage: It provide the function of set the state of account checking cycles, for example: set the state to archive when account checking ended, or set the state to account checking when account checking beginning.

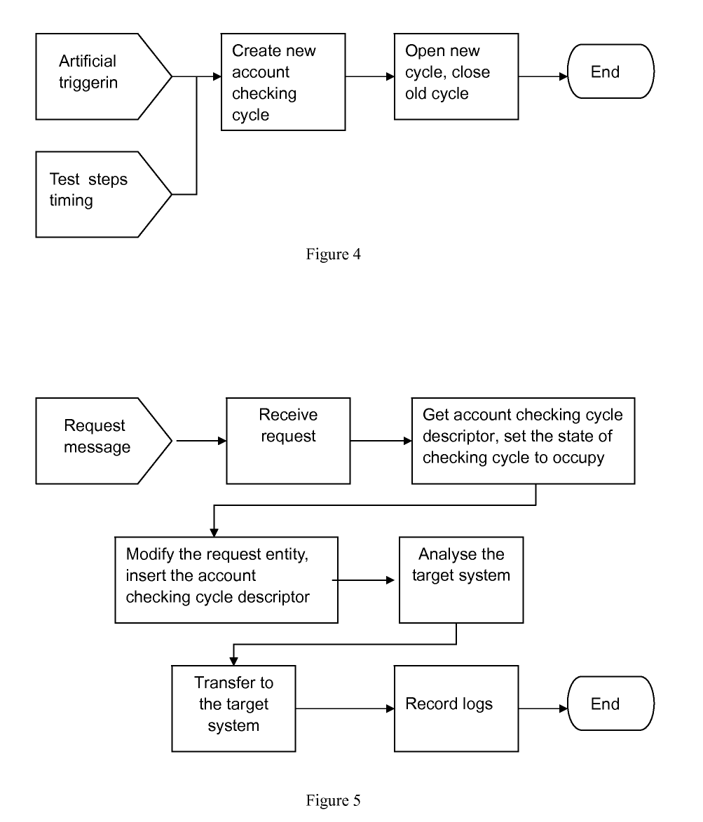

4. Transaction Flow Module
See FIG. 4, assume that a transaction is requested by system A, the opposite end is system B:
   a) System A make a request for transaction, and send it to Account Checking Controlling Server;
   b) Account Checking Controlling Server modify the transaction information which system A has requested, and insert an account checking cycle descriptor, associate the transaction with the account checking cycle, then the transaction information is transferred to system B;
   c) System B do some corresponding processing, record the transaction information data which contains an account checking cycle descriptor, and send a response information which also contains an account checking cycle descriptor to Account Checking Controlling Server;
   d) Account Checking Controlling Server transfer the system B's response information to system A;
   e) System A record the transaction request data which contains an account checking cycle descriptor.

Transaction distribute contains transfer the request information and the response information. Communication between systems can using tuxedo mode or socket mode. All transaction distributes are triggered by event. When using tuxedo mode, we can use the tuxedo's event trigger; when using socket mode, we can use the message queue of System V to store the request and response information, transaction distribute can realize the event trigger through access the message queue.

There are two important works for request information forwarding: insert an account checking cycle descriptor and transfer the information to destination. See FIG. 5.

a) Account Checking Controlling Server receive the transaction request by event trigger;

b) Get the account checking cycle descriptor from account checking cycle management module, which associate with an account checking cycle, set the state of account checking cycle to occupy;

c) Modify the transaction request information, insert the account checking cycle descriptor which we got by step b into the transaction request information;

d) Analyze the target system according to the corresponding field in the request information;

e) Transfer the request information to target system;

f) Account Checking Controlling Server record the corresponding operation logs, as the auxiliary information for account checking.

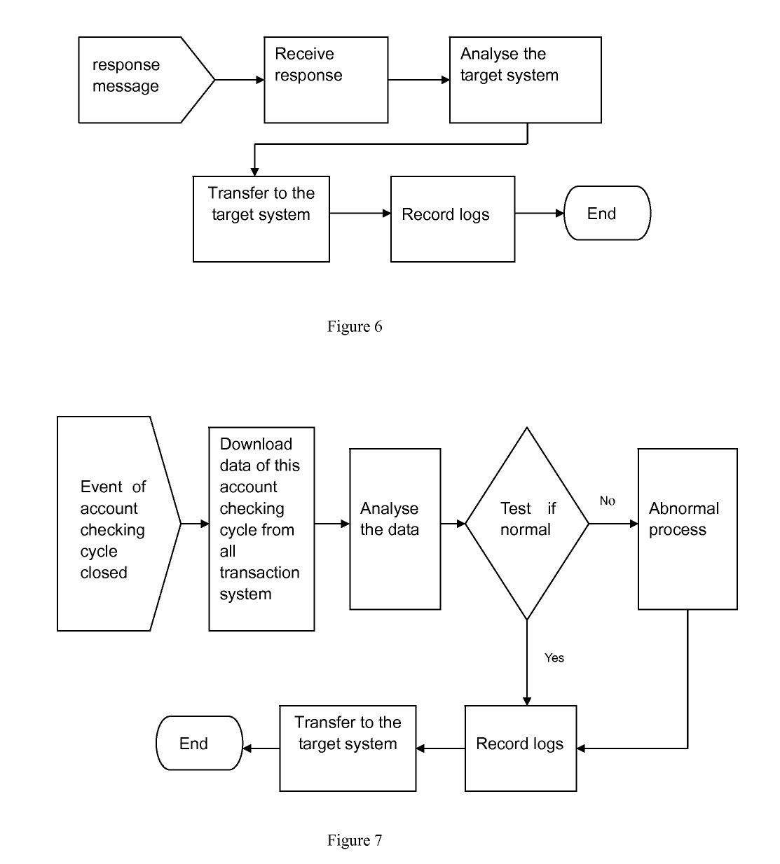

Response information forwarding is simple, it doesn't need to modify the body of information, See FIG. 6.

a) Account Checking Controlling Server receive the transaction response by event trigger;

b) Analyze the target system according to the corresponding field in the response information;

c) Transfer the response information to target system;

d) Account Checking Controlling Server record the corresponding operation logs, as the auxiliary information for account checking.

5. Participant Transaction System
Participant transaction systems here means the telecom operating systems A, B, etc shown in the FIG. 2.
The systems who participate in transaction should record the corresponding processing logs, and can provide these logs to Account Checking Controlling Server.
   Request sender: After receive the response information, the system record the processing logs which contains account checking cycle descriptor.
   Request receiver: After receive the request information, the system calculate the account checking cycle descriptor (the returned response information contains the next account checking cycle descriptor), and record the processing logs which contains account checking cycle descriptor.
   Provide logs: The system generate files according to account checking cycle, these files can be download by Account Checking Controlling Server by ftp mode.

6. Account Checking Management Module
Account checking management module is running on the Account Checking Controlling Server, when close an account checking cycle, the operations of account checking is automatically invoked. The flow of account checking management specific realization as FIG. 7:
a) Detect the state of the account checking cycle which is closed;
b) Download the transaction data of this account checking cycle from all systems by ftp mode;
c) Analyze the data, check whether there is abnormal data;
d) If the data is normal, record logs directly, and modify the state of the account checking to archive;
e) If the data is abnormal, do some adjustments, then record logs, and modify the state of the account checking to archive.

What is claimed is:

1. An account checking controlling server for checking transactions between telecom multiple systems comprising:
multiple systems are connected with the Account Checking Controlling Server respectively, transactions between systems are distributed by the account checking controlling server, which is in charge of control and manage the transaction of account checking between systems;
the account checking controlling server consists of a transaction management module, an account checking cycle management module, an transaction flow module and an account checking management module;
the transaction management module is in charge of storage and handle system information and system distribute rules;
the account checking cycle management module is responsible for create account checking cycle and manage it, each transaction of system associate with an account checking cycle, account checking cycle including attributes as follows: account checking cycle descriptor (an unique descriptor of an account checking), start time (a transaction's start time of an account checking), end time (a transaction's end time of an account checking), state of account checking cycle (1. occupy: a cycle is in transaction now; 2. close: a cycle had already closed, waiting for account checking; 3. account checking: a cycle is in account checking now; 4. archive: account checking had already finished);
the transaction flow module is in charge of specific transaction and distribute it between systems according to the account checking cycle.
the account checking management module is responsible for collect the transaction data, and provides account checking operations according to the account checking cycle.

2. The account checking controlling server of claim 1, wherein the transaction management module can provide a function of add, modify, delete the system information and the system distribute rules, the system information including: system descriptor, hostname, host ip, log directory, user/password, the system distribute rules including: section No., system descriptor (it's a reference to system descriptor in system information).

3. The account checking controlling server of claim 1, wherein in the account checking cycle management module, the start time and the end time of account checking cycle is shielding outside and is just managed in Account Checking Controlling Server by account checking cycle management module according to cycles switching event, a cycles switching event is triggered by the external according to cycle or by artificial; the system get an account checking cycle descriptor for each transaction, and associate the transaction with the account checking cycle, later, account checking is based on the account checking cycle, the action of account checking is defined as an operation process of transactions comparison in an account checking cycle.

4. The account checking controlling server of claim 3, wherein the cycles switching event specific realization as follows: set the step of account checking cycle, and account checking cycle management module can create a new account checking cycle according to a step we have already set or by an artificial event, at same time it closes last account checking cycle.

5. A method for the account checking controlling server to check transactions between telecom multiple systems of claim 1 comprising:
the transaction flow module specific realization is: assume that a transaction is requested by system A, the opposite end is system B:
a) System A make a request for transaction, and send it to Account Checking Controlling Server;
b) Account Checking Controlling Server modify the transaction information which system A has requested, and insert an account checking cycle descriptor, associate the transaction with the account checking cycle, then the transaction information is transferred to system B;
c) System B do some corresponding processing, record the transaction information data which contains an account checking cycle descriptor, and send a response information which also contains the account checking cycle descriptor to Account Checking Controlling Server;
d) Account Checking Controlling Server transfer the response information (from system B) to system A;
e) System A record the transaction information data which contains the account checking cycle descriptor.

6. The method of claim 5, wherein the transaction flow module using tuxedo mode or socket communication mode to transfer the transaction request information and transaction response information, when using tuxedo mode, the tuxedo's event trigger is used; when using socket mode, the message queue of System V is used to store the request and response information, transaction distribute can realize the event trigger through access the message queue;
Request information forwarding specific realization as follows:
a) account checking controlling server receive the transaction request by event trigger;
b) get an account checking cycle descriptor from account checking cycle management module, which associate with an account checking cycle, set the state of account checking cycle to occupy;
c) modify the transaction request information, insert the account checking cycle descriptor (which we got by step b) into the transaction request information;
d) analyze the target system according to the corresponding field in the request information;
e) transfer the request information to target system;
f) account Checking Controlling Server record the corresponding operation logs, as the auxiliary information for account checking;
response information forwarding specific realization as follows:
a) account checking controlling server receive the transaction response by event trigger;
b) analyze the target system according to the corresponding field in the response information;
c) transfer the response information to target system;
d) account checking controlling server record the corresponding operation logs, as the auxiliary information for account checking.

7. The method of claim 5, wherein when close an account checking cycle, account checking management module is automatically invoked to do the operations of account checking, account checking management specific realization as follows:
a) detect the state of the account checking cycle which is closed;
b) download the transaction data of this account checking cycle from all systems by ftp mode;
c) analyze the data, check whether there is abnormal data;
d) if the data is normal, record logs directly, and modify the state of the account checking cycle to archive;
e) if the data is abnormal, do some adjustments, then record logs and modify the state of the account checking cycle to archive.
